(19) United States
(12) Patent Application Publication
(10) Pub. No.: US 2024/0375612 A1
(43) Pub. Date: Nov. 14, 2024

(54) SECURE MULTI-BUS CONTROL SYSTEM FOR RECREATIONAL VEHICLES

(71) Applicant: Polaris Industries Inc., Medina, MN (US)

(72) Inventors: Timothy Norstad, Turtle Lake, WI (US); Monica E. Mitchell, Royal Oak, MI (US)

(21) Appl. No.: 18/657,978

(22) Filed: May 8, 2024

Related U.S. Application Data
(60) Provisional application No. 63/465,612, filed on May 11, 2023.

(51) Int. Cl. B60R 25/30; B60R 16/023; H04L 9/40

(52) U.S. Cl. CPC B60R 25/30; B60R 16/0231; H04L 63/029

(57) ABSTRACT

A vehicle control system for recreational vehicles, designed to enhance the security and functionality of communication between various devices. The system includes a first communication bus for connecting devices, such as a first vehicle controller, responsible for controlling critical vehicle functions. Additionally, a second communication bus is provided for connecting devices, including a second vehicle controller, tasked with managing peripheral vehicle functions. The two communication buses are linked by a gateway device that enables communication between them. To ensure a secure communication environment, the system incorporates at least one firewall, which selectively allows information to pass from the second communication bus to the first communication bus via the gateway. This arrangement provides increased security and reliability in the communication and control of essential vehicle functions, while allowing for flexibility in the management of peripheral functions.

### CROSS REFERENCE TO RELATED APPLICATIONS

This application claims the benefit of U.S. Provisional Patent Application No. 63/465,612, filed May 11, 2023, entitled SECURE MULTI-BUS CONTROL SYSTEM FOR RECREATIONAL VEHICLES, the contents of which are expressly incorporated herein by reference.

### BACKGROUND

Recreational and off-road vehicles, such as ATVs, UTVs, and ROVs, utilize multiple communication systems and networks to connect individual components and ensure seamless operation. Proprietary vehicle bus architectures, such as Controller Area Network (CAN) Bus, Local Interconnect Network (LIN) Bus, and various Original Equipment Manufacturer (OEM) Bus, as well as open and general bus architectures like wired or wireless Ethernet and Low-Voltage Differential Signaling (LVDS), facilitate communication between devices and microcontrollers within the vehicle.

The rapid evolution of safety, entertainment, and communication technologies in passenger vehicles has highlighted limitations in existing vehicle bus protocols. Primarily for internal vehicle controller to controller communications, these networks could be vulnerable if directly accessed for accessory or peripheral devices. To address these challenges and enhance vehicle safety, data security, and data processing, the art requires a system that leverages various communication systems and networks while providing remote access for authorized third parties, such as vehicle manufacturers, owners, and various vehicle security services. Such a system should maintain security against unauthorized parties and components, ensuring the protection of critical vehicle functions and reliable communication within recreational and off-road vehicles.

As recreational and off-road vehicles continue to incorporate more advanced technologies and components, the importance of a secure and efficient communication system becomes increasingly critical. While existing solutions provide some level of protection and functionality, there is a growing need to integrate multiple communication networks, enable secure remote and/or diagnostic access, and ensure the smooth flow of information between vehicle components. Furthermore, the system should be adaptable to evolving technologies and maintain compatibility with various communication protocols in the industry. Considering these requirements, any additional advances in protecting critical vehicle functions and ensuring reliable communication would be well received by both manufacturers and users, enhancing the overall safety, performance, and user experience of recreational and off-road vehicles.

### SUMMARY

The present disclosure relates to control systems for vehicles, and more specifically, establishing and managing secure communication networks in recreational vehicle control system communication networks.

According to embodiments of the present disclosure, a vehicle control system for a vehicle is disclosed. Specifically, embodiments of the disclosure relate to a vehicle control system for recreational, utility, and/or off-road vehicles, such as ATVs, UTVs, and the like, that is configured to protect a main communication bus, such as a Controller Area Network (CAN) bus, from accidental or intentional interference by non-critical devices, such as vehicle accessories.

One or more embodiments of the disclosure achieve this by providing a plurality of distinct vehicle communication buses that are routed and connected for communication via one or more vehicle gateway devices in the vehicle control system. In various embodiments, vehicle critical components, such as those which are configured for safety related or mission critical functions—for example those that are necessary for the vehicle operation, preventing vehicle inhibition, essential functionality, and the like—are segregated or otherwise isolated from other non-critical vehicle components. In such embodiments, communications for critical vehicle functions are secured from communications for peripheral vehicle functions, diagnostic tools, telematics, and other components with message monitoring and routing between critical and non-critical vehicle components performed internally through the gateway. In various embodiments this multi-bus configuration ensures that the transmission and reception of critical vehicle data, including ground speed, RPM, and gear position, remain unaffected in case of accessory failure, shorting, or the like.

Various embodiments provide benefits that are particularly evident in off-road vehicles or utility vehicles which can be susceptible to damage from the surrounding environment, such as brush, foliage, terrain, or the like. Damage to vehicle components can produce shorts or result in erroneous information on the communication bus that can interfere with critical vehicle functions. In one or more embodiments the gateway secures critical vehicle components and functions using a firewall that enables secure data transfer between communication buses via message ‘whitelisting.’ Further, in various embodiments the vehicle's diagnostic port can be wired through the gateway for additional protection against tampering or interference. By routing accessory devices through a gateway, the system ensures that a failure or shorted accessory harness does not affect the transmission and reception of crucial data items. This approach also provides a layer of security by placing a firewall between accessories, telematic control unit, and the vehicle's other controllers, to protect against tampering with ECUs or interference.

As such, one or more embodiments are directed to a vehicle control system comprising a first communication bus configured to facilitate communication among one or more connected devices including a first vehicle controller that is configured to control a critical vehicle function. In various embodiments the system further comprises a second communication bus configured to facilitate communication among one or more connected devices including a second vehicle controller that is configured to control a peripheral vehicle function. In one or more embodiments the vehicle control system further comprises a gateway device connecting the first and second communication bus and enabling communication between, and at least one firewall configured to define a secure communication environment for the first communication bus by selectively allowing information to pass, via the gateway, to the first communication bus from the second communication bus.

One or more embodiments are directed to a method of exchanging information with a control system for a vehicle. In one or more embodiments the method includes providing a first communication bus configured to facilitate communication among one or more connected devices including a first vehicle controller that is configured to control a critical vehicle function and providing a second communication bus configured to facilitate communication among one or more connected devices including a second vehicle controller that is configured to control a peripheral vehicle function. In one or more embodiments the method further comprises providing a gateway device connecting the first and second communication bus and enabling communication between them. And in various embodiments the method further comprises providing at least one firewall configured to define a secure communication environment for the first Communication bus by selectively allowing information to pass, via the gateway, to the first communication bus from the second communication bus.

One or more embodiments of the disclosure are directed to a vehicle control system for an off-road vehicle. In one or more embodiments the system comprises a first controller area network (CAN) bus, configured to facilitate communication among one or more connected devices including a vehicle display device configured to provide information related to the vehicle's performance and operating conditions, an electronic control module (ECM), and a vehicle control module (VCM), wherein the one or more connected devices on the first CAN bus are configured to control one or more critical vehicle functions. In one or more embodiments the system further comprises a second controller area network (CAN) bus, configured to facilitate communication among one or more connected devices configured to control a peripheral vehicle function. In one or more embodiments the system further comprises a gateway device connecting the first and second CAN buses and enabling communication between the first and second CAN buses. In various embodiments the system further comprises a firewall configured to define a secure communication environment for the first CAN bus by selectively allowing information to pass to the first CAN bus from at least the second CAN bus such that communication is monitored and controlled between the one or more devices configured to control the peripheral vehicle function and the one or more devices configured to control the one or more critical vehicle functions.

The above summary is not intended to describe each illustrated embodiment or every implementation of the present disclosure.

### BRIEF DESCRIPTION OF THE SEVERAL VIEWS OF THE DRAWINGS

The drawings included in the present application are incorporated into, and form part of, the specification. They illustrate embodiments of the present disclosure and, along with the description, serve to explain the principles of the disclosure. The drawings are only illustrative of certain embodiments and do not limit the disclosure.

FIG. 1 depicts a perspective view of an off-road vehicle, according to one or more embodiments of the disclosure.

FIG. 2 depicts a schematic block diagram of a vehicle control system, according to one or more embodiments of the disclosure.

FIG. 3 depicts a schematic block diagram of a communication bus, according to one or more embodiments of the disclosure.

FIG. 4 depicts a schematic block diagram of a vehicle control system, according to one or more embodiments of the disclosure.

FIG. 5 depicts a method of data monitoring data communication in a gateway in a vehicle control system, according to one or more embodiments of the disclosure.

While the embodiments of the disclosure are amenable to various modifications and alternative forms, specifics thereof have been shown by way of example in the drawings and will be described in detail. It should be understood, however, that the intention is not to limit the disclosure to the particular embodiments described. On the contrary, the intention is to cover all modifications, equivalents, and alternatives falling within the spirit and scope of the disclosure.

### DETAILED DESCRIPTION

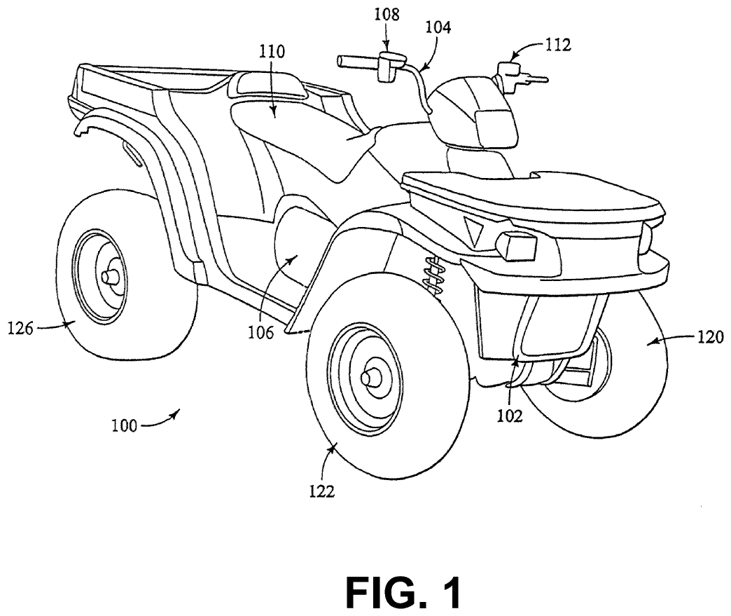

Referring to FIG. 1 a perspective view of a recreational vehicle 100 is depicted. In one or more embodiments the vehicle 100 is generally designed as an all-terrain vehicle (ATV) and comprises a frame 102 supporting a straddle-type seat 110, which is narrow enough for the rider to straddle comfortably. However, in various embodiments the vehicle could be any type of alternative recreational vehicle. For example, the vehicle 100 could be a utility vehicle (UTV) and/or may feature any of a variety of seating designs. For example, in one or more embodiments the vehicle 100 may feature a bucket-type seat and/or an additional passenger seat beside or behind the operator seat. In one or more embodiments vehicle 100 is equipped with a set of wheels including left front wheel 120, right front wheel 122, left rear wheel 124, and a right rear wheel (not visible in FIG. 1). A handlebar 104 is used to steer the vehicle.

In one or more embodiments, the left and right front wheels 120, 122 are connected to the frame 102 via a front suspension, while the left rear wheel 124 and right rear wheel are connected through a rear suspension. An engine 106, mounted on the frame 102, propels the vehicle by providing power to the rear and/or the front wheels through a drivetrain, described further below. Certain embodiments include an input device, such as a multi-position mode switch 108, mounted on the handlebar 104 for selecting different drive modes. The switch may offer three positions corresponding to on-demand four-wheel drive, two-wheel drive with a locked differential, and two-wheel drive with an open or unlocked differential. An optional second switch 112 can be added to the handlebar 104.

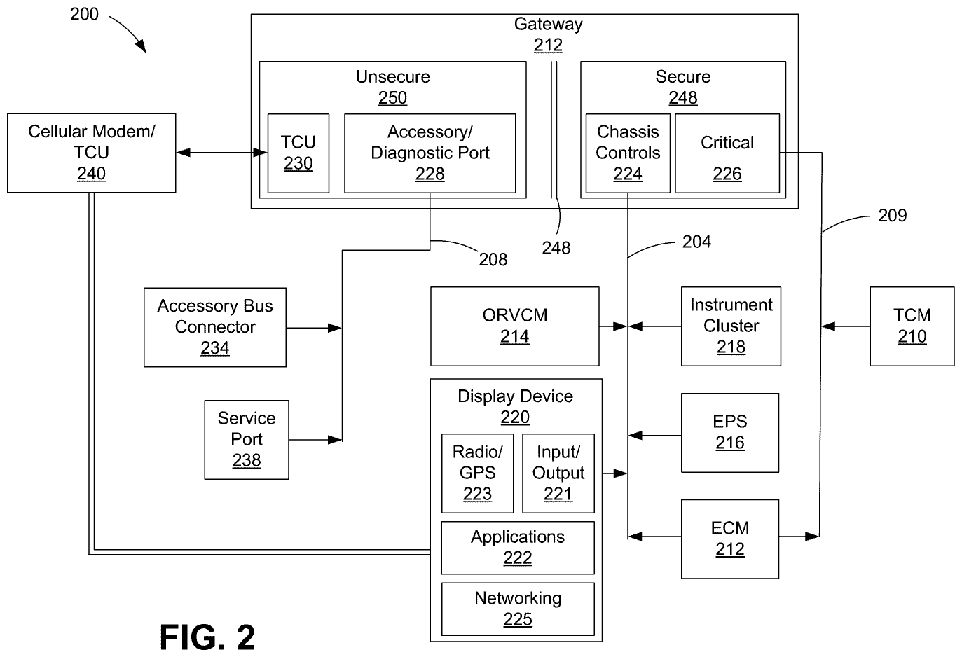

Referring to FIG. 2, a schematic block diagram of a vehicle control system 200 is depicted. In various embodiments, the vehicle control system 200 serves to manage and regulate the overall operation of a vehicle by connecting and coordinating various electronic components and systems. In one or more embodiments the vehicle control system 200 includes a first communication bus 204 configured to facilitate communication among one or more connected devices, a second communication bus 208 configured to facilitate communication among one or more connected devices, a third communication bus 209 configured to facilitate communication among one or more connected devices, and a gateway device 212 connecting the communication buses and enabling communication between.

In one or more embodiments, the first, second, and third communication bus 204, 208, 209 represent any suitable type of bus structure/architecture for communicatively connecting the individual components and/or circuitry of the vehicle control system 200. For example, in one or more embodiments the communication buses could include proprietary vehicle bus architectures, such as Controller Area Network (CAN) Bus, Local Interconnect Network (LIN) Bus, and various Original Equipment Manufacturer (OEM) Bus, as well as open and general bus architectures like wired or wireless Ethernet and Low-Voltage Differential Signaling (LVDS), to facilitate communication between devices and controllers within the vehicle. Additional discussion of vehicle communication buses and networks can be found in U.S. Patent Publication 2011/0144863, which is incorporated by reference herein.

The vehicle control system 200 includes a plurality of devices and/or controllers that are configured for performing one or more vehicle functions. For example, depicted in FIG. 2, the system 200 includes a transmission control module 210, engine control module 212, vehicle control module 214, electronic power steering 216, instrument cluster 218, and a digital display 220. In one or more embodiments, the transmission control module 210 is configured to manage and/or regulate the operation of the vehicle's transmission system. For example, managing vehicle gear shifting, torque converter control, transmission fluid pressure, and the like. In such embodiments, by monitoring various input parameters such as vehicle speed, engine load, and throttle position, the transmission control module 210 optimizes transmission performance and fuel efficiency while ensuring smooth and reliable operation.

In various embodiments the engine control module 212 is configured for managing the vehicle's engine. For example, where vehicle is configured with an internal combustion engine, the module 212 can be configured to receive input from various sensors, such as air-fuel ratio, throttle position, and engine temperature, and to control critical functions, including ignition timing, fuel injection, and emissions control. In such embodiments, by using this data to adjust the operation of the engine, the engine control module 212 maximizes engine performance, efficiency, and compliance with emission standards. In one or more embodiments the vehicle control module 214 is configured to oversee the overall operation of the vehicle, integrating and coordinating the functions of various subsystems. In such embodiments the vehicle control module 214 is configured to communicate with other controllers, such as the transmission control module 210 and the engine control module 212, to synchronize vehicle operation and optimize performance. The vehicle control module 214 may also manage other vehicle functions, such as stability control, traction control, and suspension adjustments.

In one or more embodiments, the electronic power steering 216 controls the vehicle's power steering system, adjusting the level of steering assistance based on input from sensors, such as vehicle speed and steering wheel angle. In such embodiments the power steering module 216 provides optimal steering feel and responsiveness for the driver under various driving conditions. In various embodiments the instrument cluster 218 displays essential vehicle information, such as speed, fuel level, and engine temperature, to the driver using analog or digital gauges.

In one or more embodiments the digital display 220 serves as an interface for the driver to interact with various vehicle systems, including infotainment, navigation, and vehicle settings, providing a user-friendly and customizable experience. In one or more embodiments the display 220 includes one or more of a processor or a controller and other portions such as a memory. Further, in various embodiments the display 220 includes an input/output 221, such as a keyboard, touchscreen, display, and the like for receiving using inputs and indicating information to the user. Further, in various embodiments the display 220 can include a radio/GPS system 223 and/or a networking device 225, such as a gateway, for communication with external devices. In one or more embodiments the display 220 further includes selected instructions or applications 222 that are stored on memory, for example stored locally and/or accessible via the cloud, for operation of the vehicle components.

In one or more embodiments, the gateway device 212 is a networking node that is configured as a router, switch, or gateway for allowing data communication between elements of the system 200. For example, in various embodiments the gateway 212 includes a plurality of ports including a control port 224, a critical function port 226, an accessory/diagnostic port 228, and a telematics port 230. In such embodiments, the gateway 212 is configured to facilitate networked communications between one or more elements within the system 104, for example by managing, monitoring, and passing information between various ports and their respective connected components. In certain embodiments gateway 212 could be included in one or more of the vehicle components. For example, in certain embodiments the gateway 212 could be the networking device 225 of the display 220.

Depicted in FIG. 2, the vehicle control module 214, engine control module 212, power steering 216, and instrument cluster 218 are connected to the first communication bus 204 which in turn is connected to the control port 224. The transmission control module 210 is connected to the critical function port 226 via the third communication bus 209. The engine control module 212 is connected to one or both first and third communication bus 204, 209. In various embodiments the control port 224 of the gateway device 212 handles the data communication for vehicle functions, such as the vehicle control module 214, engine control module 212, power steering 216, and the instrument cluster 218. These components require the exchange of information for basic vehicle operation. The critical function port 226 manages the communication for the transmission control module 210. Transmission control is a critical function where a delay, disruption, or error in data communication could potentially compromise the vehicle's safe operation.

As used herein, the components on the control bus 204 and the safety critical bus 209 are generally referred to as being configured to control one or more critical vehicle functions. A “critical vehicle function” within the context of this disclosure and the prior discussion refers to those functions that are essential to the safe, reliable, and efficient operation of the vehicle. These include, but are not limited to, systems and components related to engine management, transmission control, and braking systems. Specifically, these functions involve controlling the vehicle's movement, maintaining its stability, and ensuring the driver's ability to command the vehicle under various conditions. They are deemed “critical” because any disruption, error, or delay in their operation could potentially compromise the vehicle's safety, or operation, leading to hazardous situations. Furthermore, these functions typically require fast, reliable, and secure data communication, given their direct influence on the vehicle's operational performance.

In contrast, a “non-critical vehicle function” or a “peripheral vehicle function”, within the context of this disclosure and the prior discussion, refers to those functions or systems in a vehicle that, while enhancing the vehicle's operation, user experience, or comfort, are not directly involved in the vehicle's safe and essential operation. These functions are not considered critical to the vehicle's safety or primary operation and a failure, delay, or disruption in their operation would not directly endanger the vehicle or its occupants. Examples of such peripheral functions may include the vehicle's entertainment systems, such as audio and video systems, lighting systems including interior ambient lighting, climate control systems, and various other accessories like power windows, power seats, onboard navigation, and the like. While these functions can enhance the user's experience and comfort, their operation is not directly tied to the vehicle's essential performance or safety.

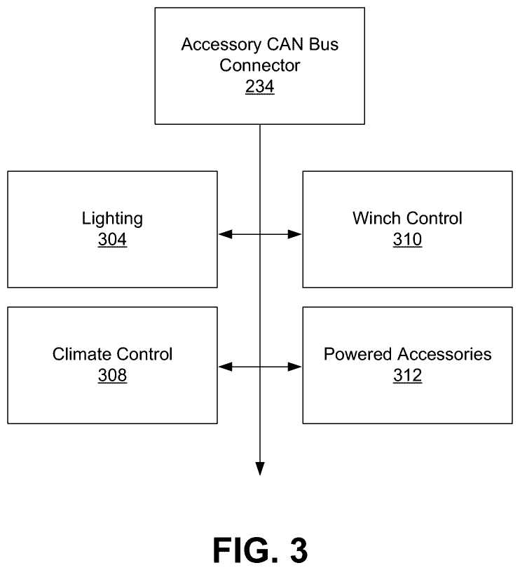

In one or more embodiments, the system 200 further includes an accessory bus connector 234 and a diagnostic port 238. The accessory bus connector 234 is a peripheral device connector that is coupled to the second communication bus 208 and the accessory/diagnostic port 228. The connector 234 is configured to be coupled with one or more devices managing peripheral or non-critical vehicle functions, such as entertainment systems, lighting, and other non-critical accessories. For example, referring additionally to FIG. 3, the accessory bus connector 234 can include a plurality of connections to devices configured for peripheral functions that include the vehicle's lighting systems 304 including interior ambient lighting, climate control systems 308, winch control systems 310, and various other powered accessories 312 like power windows, power seats, onboard navigation, and the like.

In various embodiments, the accessory bus connector 234 is configured to facilitate both power supply and data transmission to the peripheral devices. For example, in one or more embodiments the connector 234 includes a combination of power and data lines, allowing for the simultaneous delivery of power and exchange of information between the peripheral devices and the vehicle control system 200. This design ensures the efficient and reliable operation of peripheral devices while enabling their integration into the broader system 200.

In various embodiments the diagnostic port 238 is configured to provide a direct communication channel for diagnostic tools and equipment to access various components of the system 200. In such embodiments the diagnostic port 238 is typically utilized for maintenance, troubleshooting, and software updates, among other procedures. Depicted in FIG. 2, it is linked to the accessory/diagnostic port 228 of the gateway device 212, thereby permitting controlled communication with the vehicle control system 200. As described above, in one or more embodiments, the gateway 212 includes a telematics port 230, that serves as a connection point for a cellular modem or telematics control module 240. In such embodiments the module 240 enables the vehicle to communicate with external systems and networks. The telematics port 230 allows for the exchange of data between the vehicle and remote systems, providing a range of functionalities such as remote diagnostics, fleet management, emergency services, over-the-air software updates, and the like.

In one or more embodiments the gateway 212 further includes a firewall 244. The firewall 244 can be configured to define a secure communication environment 248 for one or more of the communication buses by selectively allowing information to pass, via the gateway 212, between communication buses in the secure environment 248 from communication buses and/or components that are positioned outside of the secure environment 248—referred to herein as an unsecured environment 250.

In one or more embodiments the chassis control port 224 and critical function port 226 and associated first and third communications buses are placed in the secured environment 248 such that the associated components with crucial functionality are separated or managed apart from components with peripheral functionality. This separation allows for the optimization of user experience features without risking interference with the reliable operation of critical vehicle functions. In such embodiments the gateway device 212 and/or firewall 248 serves as the intermediary that facilitates communication between the communication buses. For example, the first communication bus 204 and third communication bus 209 are intended for communication among devices that control critical vehicle functions, such as engine management, transmission control, and braking systems. These are functions integral to the safe and efficient operation of the vehicle, and as such, require a dedicated and robust communication channel to ensure reliable operation. On the other hand, the second communication bus 208 is devoted to communication among devices managing peripheral vehicle functions. These include the entertainment systems, lighting, and other non-critical accessories that enhance the user experience but do not directly influence the vehicle's core operation. By segregating these peripheral functions onto a separate bus, the system 200 ensures that any disruptions or faults within these systems do not compromise the critical vehicle functions.

As the bridge between the secured and unsecured environments 248, 250, the gateway device 212 allows for controlled and secure communication between the devices connected to each bus. This ensures that the critical and non-critical functions of the vehicle can operate concurrently and cohesively, with the gateway device 212 acting to maintain the security and integrity of the system's communication network. In various embodiments, the gateway 212 monitors and secures communication traffic through the firewall 244 using any suitable method. For example, in various embodiments the firewall 244 utilizes a messaging whitelisting process to determine when messages are approved for transmission from the unsecured 250 to secured 248 environments. Additional examples of gateway/firewall messaging can be found in U.S. Pat. Nos. 7,356,832; 9,173,100; and 10,389,744. These patents are incorporated by reference herein.

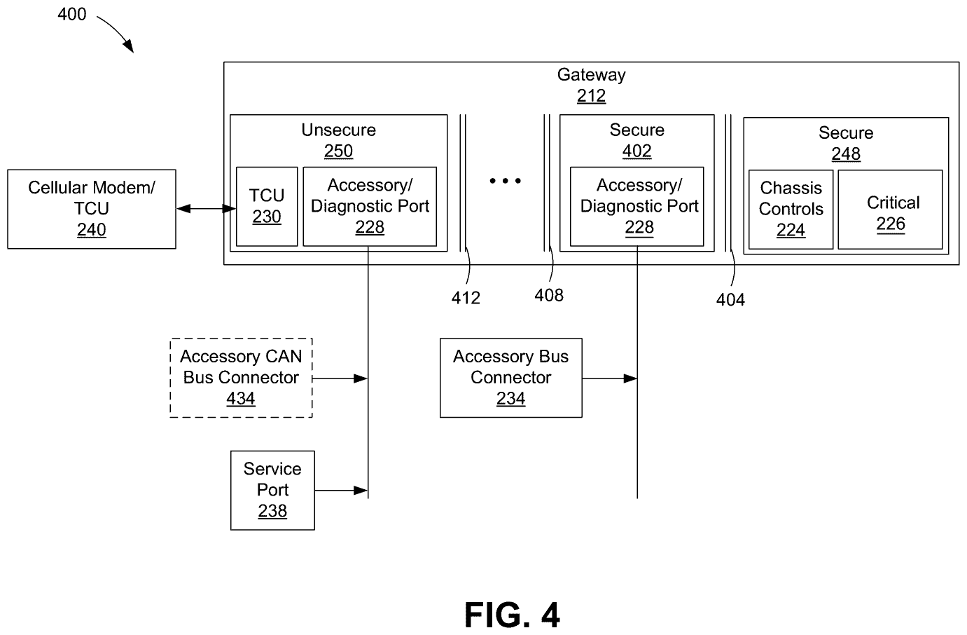

Referring to FIG. 4, in various embodiments the gateway 212 can include a plurality of firewalls 404, 408, 412 to define a plurality of secure environments 248, 402. For example, depicted in FIG. 4, the gateway 212 defines a first firewall 404 and a first secured environment 248 with a second firewall 408 and a second secured environment 402. In accordance with one or more embodiments, the gateway 212 is configured to establish multiple secure communication environments through the implementation of multiple firewalls 404, 408, 412. By implementing these firewalls, the gateway 212 can compartmentalize and isolate individual buses or groups of devices, offering varying levels of protection and separation between the connected components. This design allows for enhanced control and management of communication within the vehicle control system 200 and ensures that critical and non-critical functions are appropriately segregated. For instance, in certain embodiments, the gateway 212 can allocate specific buses or groups of devices to different secure environments, based on their functional importance or vulnerability to failures. In this way, accessories that are more prone to faults or shorts can be isolated within their own bus, thereby reducing the potential impact of such failures on the overall system. This organization not only helps to maintain the integrity of the vehicle control system 200 but also ensures that more crucial functions remain unaffected by any issues arising from less critical accessories. Additionally, the multiple secured environments established by the gateway 212 can help to prevent cascading failures that may otherwise propagate through the system. By compartmentalizing and isolating different buses and devices, the gateway 212 can effectively limit the spread of any issues that may arise, thus safeguarding the overall functionality of the vehicle control system 200.

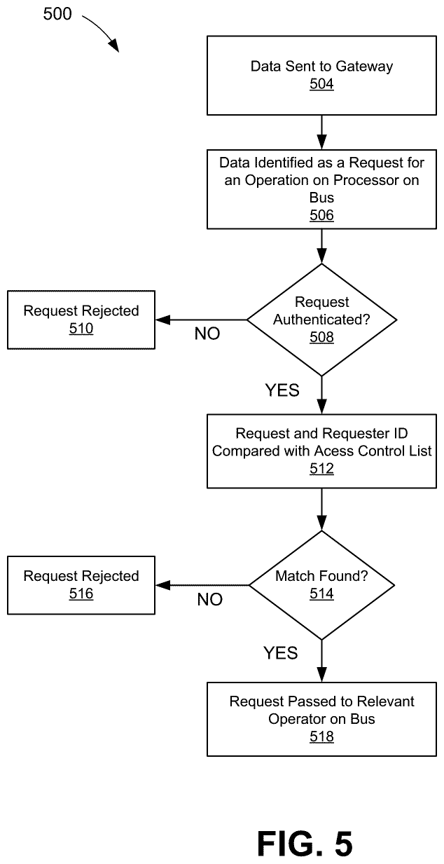

Referring to FIG. 5, a method 500 of monitoring data communication in a gateway within a vehicle control system is depicted according to one or more embodiments of the present disclosure. The method commences at operation 504, where the gateway receives data, which may originate from any device connected to the communication buses within the system. The data received could pertain to a variety of requests or instructions intended for different components within the vehicle control system. Upon receipt, the data is then identified and evaluated in operation 506, where it is determined if the data constitutes a valid request for an operation on a specific component or processor within the communication bus system. This validation process may involve examining the data request's syntax, structure, or even the originating device's identity. Should the data or request pass this verification phase, the method 500 advances to operation 512. If, however, the data or request fails the verification process, the gateway then rejects the data or request at operation 516. In this event, the gateway effectively blocks or restricts the propagation of the non-verified data or request within the system, thereby maintaining the integrity and security of the communication environment. In operation 512, the verified data or request is further scrutinized against an access control list. This comparison determines if the request is permitted based on a message whitelisting protocol. The whitelisting protocol serves to further reinforce the secure communication environment by allowing only pre-approved data requests to be passed through the gateway. In the scenario where the data or request aligns with an approved request on the message whitelist, the method 500 proceeds to operation 518. Conversely, if the data or request fails to match with an approved request on the whitelist, it is once again rejected at operation 516, and the gateway restricts the communication of the received data. Lastly, in operation 518, the request that has successfully passed the verification and whitelisting stages is then relayed to the relevant component or operator on the intended communication bus. Thus, the approved and whitelisted message is effectively communicated, maintaining the secure, efficient, and controlled operation of the vehicle control system.

The descriptions of the various embodiments of the present disclosure have been presented for purposes of illustration but are not intended to be exhaustive or limited to the embodiments disclosed. Many modifications and variations will be apparent to those of ordinary skill in the art without departing from the scope and spirit of the described embodiments. The terminology used herein was chosen to explain the principles of the embodiments, the practical application or technical improvement over technologies found in the marketplace, or to enable others of ordinary skill in the art to understand the embodiments disclosed herein.

What is claimed is:

1. A vehicle control system for a recreational vehicle, the system comprising:
a first communication bus configured to facilitate communication among one or more connected devices including a first vehicle controller that is configured to control a critical vehicle function;
a second communication bus configured to facilitate communication among one or more connected devices including a second vehicle controller that is configured to control a peripheral vehicle function;
a gateway device connecting the first and second communication bus and enabling communication therebetween; and
at least one firewall configured to define a secure communication environment for the first communication bus by selectively allowing information to pass, via the gateway, to the first communication bus from the second communication bus.

2. The vehicle control system of claim 1, further comprising a telematic control unit (TCU), wherein the firewall is configured to define a secure communication environment for the first communication bus by selectively allowing information to pass, via the gateway, to the first communication bus from the TCU.

3. The vehicle control system of claim 1, further comprising a diagnostic port, wherein the firewall is configured to define a secure communication environment for the first communication bus by selectively allowing information to pass to the first communication bus from the diagnostic port.

4. The vehicle control system of claim 3, wherein the diagnostic port is connected to the second communication bus.

5. The vehicle control system of claim 1, wherein the second vehicle controller is selected from a group consisting of a winch control system, lighting system, climate control system, and instrument/sensor cluster.

6. The vehicle control system of claim 1, wherein the first vehicle controller is selected from a group consisting of a vehicle display device configured to provide information related to the vehicle's performance and operating conditions, an electronic control module (ECM), and a vehicle control module (VCM).

7. The vehicle control system of claim 1, wherein the first and second communication bus each form a controller area network (CAN).

8. The vehicle control system of claim 1, further comprising a third communication bus configured to facilitate communication among one or more connected devices.

9. The vehicle control system of claim 8, wherein the firewall is configured to define a secure communication environment for the first communication bus by selectively allowing information to pass to the first communication bus from the third communication bus.

10. The vehicle control system of claim 8, further comprising a second firewall configured to define a secure communication environment for the second communication bus by selectively allowing information to pass to the second communication bus from the third communication bus.

11. The vehicle control system of claim 8, wherein the third communication bus includes at least one of a connected diagnostic port and a third vehicle controller that is configured to control at least one of a peripheral vehicle function and a critical vehicle function.

12. The vehicle control system of claim 1, wherein the vehicle control system is installed into an off-road vehicle.

13. A method of exchanging information with a control system for a vehicle, comprising: providing a first communication bus configured to facilitate communication among one or more connected devices including a first vehicle controller that is configured to control a critical vehicle function, providing a second communication bus configured to facilitate communication among one or more connected devices including a second vehicle controller that is configured to control a peripheral vehicle function;
providing a gateway device connecting the first and second communication bus and enabling communication therebetween; and
providing at least one firewall configured to define a secure communication environment for the first communication bus by selectively allowing information to pass, via the gateway, to the first communication bus from the second communication bus.

14. The method claim 13, further comprising providing a telematic control unit (TCU), wherein the firewall is configured to define a secure communication environment for the first communication bus by selectively allowing information to pass, via the gateway, to the first communication bus from the TCU.

15. The method of claim 13, further comprising a diagnostic port, wherein the firewall is configured to define a secure communication environment for the first communication bus by selectively allowing information to pass to the first communication bus from the diagnostic port.

16. The vehicle control system of claim 15, wherein the diagnostic port is connected to the second communication bus.

17. The vehicle control system of claim 13, wherein the second vehicle controller is selected from a group consisting of a winch control system, lighting system, climate control system, and instrument/sensor cluster.

18. The vehicle control system of claim 13, wherein the vehicle control system is installed into an off-road vehicle.

19. A vehicle control system for a recreational vehicle, the system comprising:
a first controller area network (CAN) bus, configured to facilitate communication among one or more connected devices including a vehicle display device configured to provide information related to the vehicle's performance and operating conditions, an electronic control module (ECM), and a vehicle control module (VCM), wherein the one or more connected devices on the first CAN bus are configured to control one or more critical vehicle functions;
a second CAN bus, configured to facilitate communication among one or more connected devices configured to control a peripheral vehicle function;
a gateway device connecting the first and second CAN buses and enabling communication between the first and second CAN buses; and
a firewall configured to define a secure communication environment for the first CAN bus by selectively allowing information to pass to the first CAN bus from at least the second CAN bus such that communication is monitored and controlled between the one or more devices configured to control the peripheral vehicle function and the one or more devices configured to control the one or more critical vehicle functions.

20. The system of claim 19, wherein the peripheral vehicle function comprises at least one of a vehicle entertainment system, an audio system, a display, a lighting system, a climate control system, a power window system, a power seat system, and an onboard navigation system.
